(19) United States
(12) Patent Application Publication
(10) Pub. No.: US 2018/0183623 A1
(43) Pub. Date: Jun. 28, 2018

(54) Method for Operating a Sensor Device, Sensor Device

(71) Applicant: Robert Bosch GmbH, Stuttgart (DE)

(72) Inventors: Daniel Schoenfeld, Abstatt (DE); Marlon Ramon Ewert, Untergruppenbach (DE)

(21) Appl. No.: 15/849,890

(22) Filed: Dec. 21, 2017

(30) Foreign Application Priority Data
Dec. 23, 2016 (DE) 10 2016 226 136.3

(51) Int. Cl. H04L 12/403; H04L 29/08; H04L 12/40

(52) U.S. Cl. CPC H04L 12/403; H04L 67/12; B60R 21/01; H04L 2012/40273; H04L 12/40019

(57) ABSTRACT

A method for operating a sensor device of a motor vehicle where the sensor device has sensors and a control device includes electrically connecting the sensors to the control device for signaling. One of the sensors is connected directly to the control device as a master sensor and the remaining sensors are connected to the master sensor as slave sensors. The method further includes controlling the master sensor to convey sensor data of the sensors to the control device. The method further includes processing the conveyed sensor data with the control device.

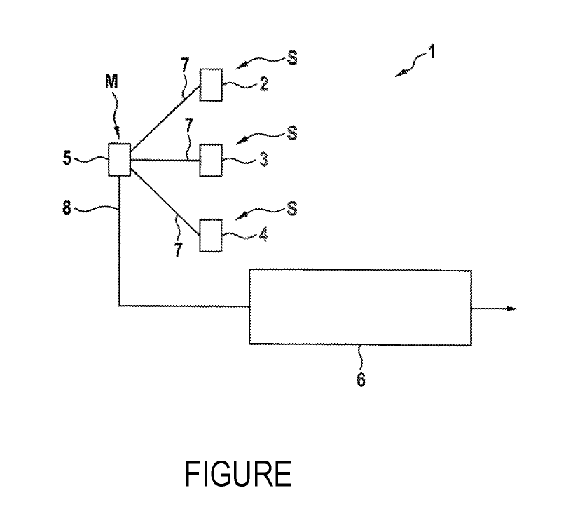

This application claims priority under 35 U.S.C. § 119 to patent application no. DE 10 2016 226 136.3 filed on Dec. 23, 2016 in Germany, the disclosure of which is incorporated herein by reference in its entirety.

The disclosure relates to a method for operating a sensor device of a motor vehicle, the sensor device having a number of sensors and a control device, and the sensors being connected for signalling to the control device and the control device processing/evaluating sensor values detected by the sensors.

Furthermore, the disclosure relates to a corresponding sensor device having a number of sensors and having a control device which is connected for signalling to the sensors in order to process or evaluate the sensor values detected.

### BACKGROUND

Methods and sensor devices of the type mentioned initially are already known from the prior art. In order to increase the safety of vehicle passengers and of other road users outside of the vehicle, it is known to use sensor devices which, with the aid of sensors installed in a motor vehicle, detect an occurring or threatening accident and, if necessary, control and trigger one or more safety devices of the motor vehicle such as, for example, belt tighteners, airbags or the like. To detect rear-end collisions or frontal crashes, acceleration sensors are used these days which are mostly installed in the central control device and/or along a bending cross-arm of the motor vehicle. To detect side crashes, pressure and/or acceleration sensors are preferably used today, acceleration sensors being usually inserted at the B, C or D column of the motor vehicle and pressure sensors being inserted in the motor vehicle door. The amplitude of the output signal of the respective sensor as a rule forms the sensor data to be evaluated which are decisive for the triggering or non-triggering of one of the safety devices. Normally, the amplitude is dependent on the mass and the velocity of the impinging object. For the detection of pedestrian accidents, it is also known to arrange sensors in the vehicle bumper, for example, two or more acceleration sensors or also pressure-hose-based systems.

The sensor values or output signals output by the sensors are processed further by a control device by means of corresponding algorithms in order to render the triggering decision. If it is then detected that a pedestrian impact, side crash or frontal crash has taken place, correspondingly advantageous retaining means are activated or triggered in the motor vehicle in dependence on this triggering decision.

It is also known to use environmental sensors installed in the vehicle such as, for example, radar, camera, ultrasonic or lidar sensors in order to detect an impending collision. By means of these sensors, it is then provided, for example, to adjust a triggering threshold in the control device to be sensitive or robust depending on what object has been detected by the environmental sensor system. By this means, the triggering of the active retaining means can be improved.

For the communication between the sensors and the control device, different communication protocols are already being used. The PSI5 protocol is an open standard which has been initiated by several manufacturers by which up to four sensors per bus node can be handled in different configurations. A bidirectional communication for sensor configuration is also possible by means of this protocol. In airbag systems, for example, data from pressure or acceleration sensors are evaluated via current-modulated two-wire buses which communicate with the control device via a Manchester-coded protocol. In this context, the communication can take place in different ways, a distinction being made firstly between synchronous and asynchronous operating modes. In the case of the synchronous operating modes, the three operating modes of parallel bus mode, in which the sensors are connected in parallel, universal bus mode, in which the sensors are serially interconnected, and daisy-chain bus mode are produced in the interconnection of the sensors with the control device. Combined with other parameters such as the total number of time slots, data rate, data word length, parity/CRC monitoring, the PSI5 protocol allows different possibilities of implementation. The 10-bit data word length is widely used.

The number of sensors in the vehicle increases continuously. As a result, the bus systems are loaded further. In the sensors, communication interfaces are usually deposited by means of which the data exchange between sensors and the control device is implemented in the vehicle. Usually, a separate, complete communication interface is deposited in each sensor as a result of which the sensors are designed to be relatively complex. Sensors which communicate via the PSI5 protocol are, as a rule, connected to a control device via a bus link or directly. The data exchange takes place within fixedly defined times. This means the data words from the sensors are transmitted in fixedly defined cycles.

From the prior art, for example from DE 42 01 642 A1, it is known to set up a master-slave communication in complex networks in order to drive a number of slaves by means of a master. From the patent application U.S. Pat. No. 6,188,314 B1, a communication system is also already known, having a central unit and a plurality of remote units, the central unit supplying the remote units with energy. From patent application EP 1 349 326 A1, a further communication system having a master and a number of slave devices is known, the slave devices being connected to the master and sensor data being transmitted to the master on request of the master.

### SUMMARY

The method, according to the disclosure, has the advantage that the sensor device is configured by an advantageous master-slave system which allows advantageous communication of the sensors with one another and with the control device. An essential advantage of the disclosure is that only one of the sensors is connected directly to the control device as master sensor and the other sensors to the master sensor as slave sensors. Communication to the control device by means of the master sensor alone is thus achieved. This achieves intelligent data transmission and provides the possibility of a further increase in the number of sensors. According to the disclosure, this is achieved by the fact that only one of the sensors is connected as master sensor to the control device and that the remaining sensors are connected to the master sensor as slave sensors, the master sensor conveying the sensor data of the sensors, that is to say its own sensor data and those of the slave sensors, to the control device. By this means, the information of the number of sensors are bundled by the master sensor and transmitted bundled to the control device. This reduces the communication expenditure between the master sensor and the control device and further sensors, especially at least one further sensor group consisting of a master sensor and a number of slave sensors, can be connected to the control device without overloading the communication of the control device. Especially in the case of using the PSI5 protocol, this results in the advantage that the number of sensors can be increased cost effectively and in an uncomplicated way.

According to a preferred embodiment of the disclosure, it is provided that the master sensor sends the sensor data or sensor values of all sensors by means of at least one data word. As already explained, the master sensor thus bundles the sensor values of the sensors and conveys them to the control device. Preferably, the master sensor sends the data to the control device by means of only one data word so that the communication is particularly streamlined or resource-saving. Alternatively, the master sensor sends the sensor values to the control device by means of a number of data values.

In particular, it is provided that the master sensor in each case generates a data word for the sensor data of each sensor and sends them successively to the control device. Such a serial communication allows each sensor value or data record to be transmitted individually to the control device so that, after the master sensor has transmitted the sensor data for all sensors of the group to the control device and the control device has all the necessary sensor values, the transmitted data word consists in each case of precisely the sensor data or the sensor value of an individual sensor of the group. By this means, a simple arrangement of the transmitted sensor values with the individual sensors by the control device is possible.

According to an alternative embodiment of the disclosure, it is preferably provided that the master sensor combines the sensor data of the sensors to form a combined data word and only sends the latter to the control device. The data word thus corresponds to a combination of the sensor data of the individual sensors which, depending on design, is decrypted again into individual sensor data by the control device or is processed further as combined data word and thus as combined sensor data. A decryption into individual sensor data is possible particularly if preferably the sensor data of the sensors are serially linked with one another bit by bit for producing the combined data word. By this means, the control device receives each sensor value or each data record, in which the control device reads said sensor values or data records from the combined data word.

Alternatively, it is preferably provided that the sensor data of the sensors are compressed and then assembled to form the combined data word. Although this reduces the information density of the data word, it is sufficient for reliably triggering a safety device. Here, too, a decryption of the combined data word by the control device is also possible, if necessary. For the compressing, the data or the sensor data of the individual sensors, respectively, are preferably initially split into small parts which are combined with one another and assembled together to form the common data word. In order to transmit the complete sensor data or data of all the sensors to the control device, a number of common data words are preferably generated in order to transmit all parts of the sensor values or sensor data of the individual sensors to the control device.

According to a preferred development of the disclosure, it is provided that the sensors are set from the start as master sensor or slave sensors. This can be done especially already at the production line so that sensors are allocated their function, for example, already before assembly. Alternatively, it is preferably provided that only one sensor is predetermined as master sensor and with a first communication, the sensors connected to the master sensor are set as slave sensors by the master sensor.

In particular, it is provided that the master sensor allocates to the slave sensor in each case an unambiguous identifier. The communication between master sensor and control device is already unambiguous since only the master sensor is connected to the control device for communications or signals. In principle, the signal connections can be cable-connected or wireless, for example by radio.

The sensor device according to the disclosure is characterized by the fact that it is especially configured for performing the method according to the disclosure during normal use as intended. This results in the aforementioned advantages.

### BRIEF DESCRIPTION OF THE DRAWINGS

In the text which follows, the disclosure shall be explained in greater detail with reference to the drawing.

The FIGURE shows a sensor device for a motor vehicle in a simplified representation.

### DETAILED DESCRIPTION

The FIGURE shows in a simplified representation a sensor device 1 for a motor vehicle, not shown in greater detail here. The sensor device 1 is particularly designed as accident detection device which has a number of sensors 2, 3, 4 and 5, and a control device 6 which evaluates the sensor data conveyed or detected by the sensors 2 to 5 and, for example when required, triggers a safety device of the motor vehicle. In particular, sensors 2 to 5 are designed, for example, as acceleration sensors, as pressure sensors, as rotational speed sensors or as ultrasonic sensors or the like. A combination of such sensors can also be provided. The control device 6 compares, for example, the sensor data detected or generated by the sensors and compares these with predeterminable limit values in order to decide on the triggering or non-triggering of the safety device. The safety device can be, for example, an airbag device, a belt tightener or another activatable restraining means in the motor vehicle.

The sensors 2 to 5 and the control device 6 are designed, in particular, to communicate by means of the PSI5 protocol. In the present text, connecting lines 7 and 8 are drawn in. The connections can be wire-connected, as drawn in, or alternatively also by radio or wirelessly.

The sensor device 1 is designed in such a manner that the sensors 2 to 4 are connected to the sensor 5 by in each case one connecting line 7 and the sensor 5 by the connecting line 8 to the control device 6 so that only the sensor 5 is connected directly to the control device 6. The sensor 5 is designed as master sensor M whilst the sensors 2 to 4 are designed or set as slave sensors S.

The object of the master sensor M is to cyclically collect or detect the data of the further, particularly structurally equal sensors 2 to 5. The detected data of the individual sensors 2 to 5 are subsequently combined in the master sensor M to form a single data word and transmitted to the control device 6.

The combination of the individual data or sensor data of the individual sensors 2 to 5 can be produced in different ways:

According to the first illustrative embodiment it is provided that an alternating data transmission takes place. This means that a data word transmitted from the master sensor M consists exactly of the sensor data of a single one of the sensors 2 to 5. Once a number of data words has been transmitted by the master sensor M to the control device which corresponds to the number of single sensors 2 to 5, the sensor data for each sensor 2 to 5 are available in the control device 6 and can be evaluated.

According to a further illustrative embodiment, it is provided that a serial data transmission takes place. In this context, the sensor data of the individual sensors 2 to 5 are combined by the master sensor M to form a common data word, for example serially bit by bit, and subsequently the common data word is transmitted by the master sensor M to the control device 6. Once the data word has been transmitted, data are then present in the control device 6 for each sensor 2 to 5. In particular, the complete sensor data of the respective sensor 2 to 5 are present.

According to a further illustrative embodiment, it is provided that the data of the individual sensors 2 to 5 are initially split into smaller parts by the master sensor M, which parts are combined to form a data word. Advantageously, a number of data words are generated by the master sensor M so that the sensor data are transmitted completely to the control device 6.

Advantageously, the sensors 2 to 5 are configured as slave sensors 5 or master sensor M during the production of the sensors 2 to 5. Alternatively, configuring takes place only after the final assembly.

In particular, it is provided that the slave sensors S are designed to report to the master sensor M at the beginning of communication. An unambiguous identifier is then allocated by the master sensor M to each slave sensor. Communication between master sensor M and control device 6 is already unambiguous since only the master sensor M is connected for signalling to the control device 6.

An essential advantage of the sensor device 1 and the way in which it is operated lies in that an intelligent data transmission takes place via the PSI5 interface, whereby wiring complexity is reduced in comparison with known solutions and a streamlined or resource-saving data transmission of a data word takes place from the master sensor M to the control device 6. Because the sensors 2 to 5 are connected directly to one another, a cabling effort is also reduced, particularly to the control device 6, which also results in construction space advantages.

What is claimed is:

1. A method for operating a sensor device of a motor vehicle, the sensor device having a plurality of sensors and a control device, the method comprising:
electrically connecting the plurality of sensors to the control device for signaling, such that only one sensor of the plurality of sensors is connected directly to the control device as a master sensor and the remaining sensors of the plurality of sensors are connected to the master sensor as slave sensors;
controlling the master sensor to convey sensor data of the plurality of sensors to the control device; and
processing the conveyed sensor data with the control device.

2. The method of claim 1, further comprising:
controlling the master sensor to transmit the sensor data of the plurality of sensors to the control device using at least one data word.

3. The method of claim 1, further comprising:
controlling the master sensor to generate one data word for the sensor data of each sensor from the plurality of sensors; and
controlling the master sensor to send the data words successively to the control device.

4. The method of claim 1, further comprising:
controlling the master sensor to combine the sensor data of the plurality of sensors to form a combined data word; and
controlling the master sensor to transmit the combined data word to the control device.

5. The method of claim 4, wherein the sensor data of the plurality of sensors is combined serially bit by bit.

6. The method of claim 1, wherein the sensor data of the sensors are in each case split and then combined to form at least one combined data word.

7. The method of claim 6, further comprising:
controlling the master sensor to transmit the split sensor data to the control device using a number of combined data words.

8. The method of claim 1, wherein each of the pluralities of sensors are predetermined as a master sensor or as slave sensors.

9. The method of claim 1, further comprising:
controlling the master sensor to allocate an unambiguous identifier to the slave sensors.

10. The method of claim 1, further comprising:
controlling at least one sensor of the plurality of sensors to alternately vary the bit width.

11. A sensor device for a motor vehicle, comprising:
a plurality of sensors; and
a control device,
wherein the plurality of sensors are connected to the control device for signaling,
wherein the control device is configured to process sensor data generated by the sensors, and
wherein the sensor device is configured to perform a method, the method comprising:
electrically connecting the plurality of sensors to the control device for signaling, such that only one sensor of the plurality of sensors is connected directly to the control device as a master sensor and the remaining sensors of the plurality of sensors are connected to the master sensor as slave sensors;
controlling the master sensor to convey sensor data of the plurality of sensors to the control device; and
processing the conveyed sensor data with the control device.
